(19) United States
(12) Patent Application Publication
(10) Pub. No.: US 2010/0273407 A1
(43) Pub. Date: Oct. 28, 2010

(54) MULTI PURPOSE ROTATIONAL DRIVE SYSTEM FOR FOWL CROPPING AND FOWL CLEANING MACHINES AND THE METHOD AND USE THEREOF

(75) Inventors: Johnny Allen Chattin, Dahlonega, GA (US); Scott L. Davis, Dahlonega, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Davis Poultry Equipment, Inc.

(21) Appl. No.: 12/695,067

(22) Filed: Jan. 27, 2010

Related U.S. Application Data
(60) Provisional application No. 61/147,740, filed on Jan. 27, 2009.

(51) Int. Cl. A22C 21/06; A22C 21/00

(52) U.S. Cl. 452/106; 452/173

(57) ABSTRACT

Generally described, the invention relates to a device and method for using same which includes a module assembly which includes a drive roller which not only provides an index feature to the lower end of an elongated member (such as a cleaner or a cropper), but also provides a rotation feature as this member is inserted into the interior of a bird in order to further process it.

### CROSS-REFERENCE TO RELATED APPLICATIONS

This application claims the full benefit and priority of U.S. Provisional Application No. 61/147,740, filed Jan. 27, 2010, which is hereby incorporated by reference in its entirety.

### BACKGROUND OF THE INVENTION

1. Field of the Invention

The present invention relates generally to poultry processing equipment and more particularly, to an improved device for a poultry cleaning or cropping device in which the lower end of an elongated member (such as a cleaner or a cropper) is inserted into the interior of a bird in order to further process it.

2. Description of Related Art

U.S. Pat. No. 7,537,515, entitled: “Machine for cleaning fowl and method of use thereof”, application Ser. No. 11/698,662 filed on Jan. 26, 2007 and issued on May 26, 2009, is incorporated by reference in its entirety. U.S. Pat. No. 7,537,515 discloses a machine for cleaning fowl by removal of residual viscera and bacteria, the machine comprising a downwardly extending elongate wand with brushing tendrils attached to its lower tip, wherein the tip has exits for spraying cleaning fluid therefrom. The tip is attached to a rotating hollow shaft into which the cleaning fluid is introduced. Fowl are secured to hangers and the hangers are transported on a track to and around the machine. While passing around the machine, the wand is inserted into the fowl for cleaning thereof. The wand rides on a fixed cam comprising timed upward and downward guide tracks which transmit upward and downward movement to the wand, thereby inserting it into, and removing it from, the carcass of a fowl. Rotation of the lower tip is provided via a square shaft which is driven by a gear 330 attached thereto which engages a main ring gear 130.

US Patent Publication No PATNO 20090203303, entitled: “Machine for lung removal in poultry and method and use thereof is incorporated by reference in its entirety. Provided is an improved evisceration device and subassemblies thereof for removing organs from a membrane-covered socket in the body cavity of a poultry carcass, such as the lungs.

### BRIEF SUMMARY OF THE INVENTION

The long-standing but heretofore unfulfilled need for an innovation that overcomes the limitations of the prior art is now met by a new, useful, and nonobvious invention.

The following summary is not an extensive overview and is not intended to identify key or critical elements of the apparatuses, methods, systems, processes, and the like, or to delineate the scope of such elements. This Summary provides a conceptual introduction in a simplified form as a prelude to the more-detailed description that follows.

Generally described, the invention relates to a device and method for using same which includes a module assembly which includes a drive roller which not only provides an index feature to the lower end of an elongated member (such as a cleaner or a cropper), but also provides a rotation feature as this member is inserted into the interior of a bird in order to further process it.

In one embodiment of the present invention, the present invention provides a machine for cleaning at least part of an internal cavity in each of a plurality of fowl traveling along a conveying path, each said internal cavity having an upwardly-directed access opening, said machine comprising a cam following rail, a module assembly itself including a module assembly body configured for moving upwardly and downwardly relative to one of said fowl along at least a part of said conveying path, an elongate fowl processing element including a working lower tip portion configured for insertion to and withdrawal from at least one internal cavity through said access opening, said elongate fowl processing element being rotatably mounted relative to said module assembly body about a first axis such that said working lower tip rotates within said internal cavity, a drive cam roller rotatably mounted relative to said module assembly body about a second axis substantially perpendicular to said first axis, said drive cam roller in rolling engagement with said cam following rail, such that as said drive cam roller rolls along in engagement with said cam following rail, said working lower tip portion moves up and down within said internal cavity along a path substantially parallel to said second axis; and a power transmission subassembly intermediate said drive cam roller and said elongate fowl processing element, said power transmission subassembly configured to transmit power from said drive cam roller to said elongate fowl processing element such that said rolling engagement of said drive cam roller with said cam following rail causes rotation of said working lower tip portion about said second axis at least part of the time said working lower tip portion is within said internal cavity.

The embodiment above can also be configured wherein said rolling engagement is a toothed engagement between spaced apart teeth on said drive cam roller and spaced apart teeth on said cam following rail.

The embodiment above can also be configured wherein said spaced apart teeth on said cam following rail are individually mounted on said cam following rail.

The embodiment above can also be configured wherein said spaced apart teeth on said cam following rail are mounted on said cam following rail via use of replaceable sections each including a plurality of teeth.

The embodiment above can also be configured wherein said rolling engagement is a substantially smooth frictional engagement between said drive cam roller and said cam following rail.

The embodiment above can also be configured wherein said rolling engagement is a combination of a) toothed engagement between spaced apart teeth on said drive cam roller and spaced apart teeth on said cam following rail; and b) rolling engagement is a substantially smooth engagement between said a smooth portion of drive cam roller and said a smooth portion of said cam following rail.

The embodiment above can also be configured further comprising a retention member mounted relative to said module assembly body such that a portion of said cam following rail is captured between said drive cam roller and said retention roller, such that said drive cam roller is retained in rolling engagement with said cam following rail.

The embodiment above can also be configured wherein said retention member is a retention roller in rolling contact with said cam following rail.

The embodiment above can also be configured wherein said retention roller is biased against one side of said cam following rail and said cam drive cam follower is in contact with a second side of said cam following rail, said second side being opposite said first side.

The embodiment above can also be configured wherein said biasing of said retention roller is provided by a spring biased shaft supporting said retention roller.

The embodiment above can also be configured wherein said power transmission assembly includes a gear drive.

The embodiment above can also be configured wherein said power transmission assembly includes a flexible cable drive.

The embodiment above can also be configured wherein said lower portion of elongate fowl processing element included a cleaning head including flexible tendrils as well as cleaning fluid dispensers.

The embodiment above can also be configured wherein said lower portion of said elongate fowl processing element includes a cropper head for removing the crop.

Another embodiment of the present invention provides a method for cleaning at least part of an internal cavity in each of a plurality of fowl traveling along a conveying path, each said internal cavity having an upwardly-directed access opening, said method comprising the steps of: A) providing a machine comprising: 1) a cam following rail; and 2) a module assembly itself including: a) a module assembly body configured for moving upwardly and downwardly relative to one of said fowl along at least a part of said conveying path; b) an elongate fowl processing element including a working lower tip portion configured for insertion to and withdrawal from at least one internal cavity through said access opening, said elongate fowl processing element being rotatably mounted relative to said module assembly body about a first axis such that said working lower tip rotates within said internal cavity; c) a drive cam roller rotatably mounted relative to said module assembly body about a second axis substantially perpendicular to said first axis, said drive cam roller in rolling engagement with said cam following rail, such that as said drive cam roller rolls along in engagement with said cam following rail, said working lower tip portion moves up and down within said internal cavity along a path substantially parallel to said second axis; and d) a power transmission subassembly intermediate said drive cam roller and said elongate fowl processing element, said power transmission subassembly configured to transmit power from said drive cam roller to said elongate fowl processing element such that said rolling engagement of said drive cam roller with said cam following rail causes rotation of said working lower tip portion about said second axis at least part of the time said working lower tip portion is within said internal cavity; and B) operating said machine such that: 1) said drive cam roller is rotatably driven by said cam following rail, such that as said drive cam roller rolls along in engagement with said cam following rail, said working lower tip portion moves up and down within said internal cavity along a path substantially parallel to said second axis; and 2) said power transmission subassembly transmits power from said rotating drive cam roller to said elongate fowl processing element such that said rolling engagement of said drive cam roller with said cam following rail causes rotation of said working lower tip portion about said second axis at least part of the time said working lower tip portion is within said internal cavity.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a pictorial view of the bird cleaning apparatus 10 according to the present invention.

FIG. 2 is an isolated pictorial view of a module assembly 400 in engagement with an exemplary section of lower camming rail 164.

FIG. 3 is an isolated side elevational view of a module assembly 400 in engagement with an exemplary section of lower camming rail 164.

FIG. 4 illustrates the interaction of a drive cam roller 410 within the cam channel 162.

FIG. 5 illustrates the transfer of torque from drive cam roller 420 to drive cam roller axle 421, to drive gear 430. Drive gear 430 is in toothed engagement with driven gear 432 as shown in FIG. 5. Rotation of drive gear 430 causes rotation of driven gear 432. Driven gear 432 is rigidly mounted on driven axle 434, such that rotation of one causes rotation of the other. Driven axle threaded portion 435 is part of driven axis 434. Thus elements 432, 434, and 435 rotate as a unit and in conventional operation rotate along a vertical axis. Thus rotation of drive cam roller 420 causes rotation of driven axle threaded portion, and anything threaded onto it.

FIG. 6 is a side elevational partial view of the apparatus 10.

FIG. 7 is a pictorial exploded view of a module assembly 400.

FIGS. 8 and 9 are detailed views of a part of a module assembly 400.

FIG. 10 shows a module assembly 400 with a rotating scrub head 440 attached.

FIG. 11 shows a module assembly 400 with a rotating crop head 540 attached.

FIG. 12 shows a module assembly 400 at various stages along engagement of a cam channel.

FIG. 13 shows an alternative drive cam roller assembly 420 configuration, which includes the use of an O-ring in order to assist the transfer of torque to the drive cam roller assembly 420 due to contact between the O-ring (attached to the drive cam roller assembly 420) and the preferably smooth upper surface of the lower camming rail 164.

FIG. 14 shows an alternative to the camming gear teeth 165, in that a replaceable track segment 1000 made of flexible material is configured to be selectively attached to the upper surface of the lower camming rail 164. The notches allow for curving around the cam.

FIG. 15 shows an alternative to the camming gear teeth 165, in that multiple replaceable track segment 1100 made of flexible material are configured to be selectively attached to the upper surface of the lower camming rail 164. The interconnections allow for curving around the cam.

FIG. 16 shows an alternative configuration which includes a track with notches which is engaged by a drive wheel with slightly differently shaped teeth.

FIG. 17 shows an alternate flexible cable drive member 1700 could be used from 421 to 434, such as for example a speedometer cable.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In describing the preferred and selected alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. If an item is noted as being referenced in a drawing, this does not mean the item is not shown in another drawing.

Bird Cleaning Apparatus 10 Generally

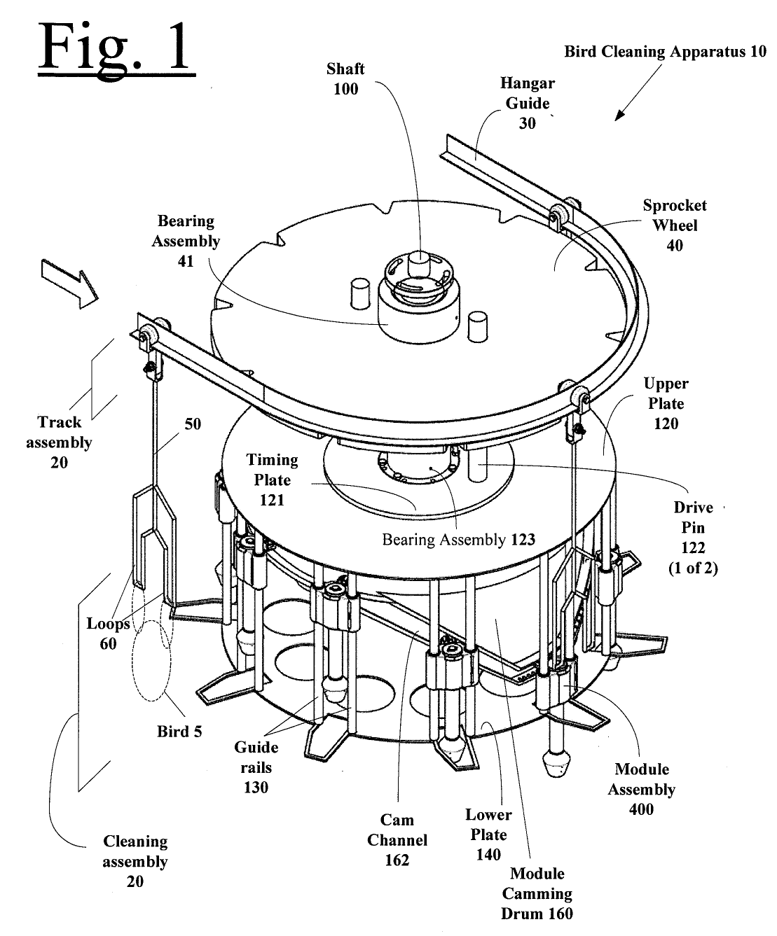

Reference is first made to FIG. 1, which shows significant portions of the bird cleaning apparatus 10

This apparatus 10 includes the following general elements:
track assembly 20
shaft 100
cleaning assembly 110
module assemblies 400

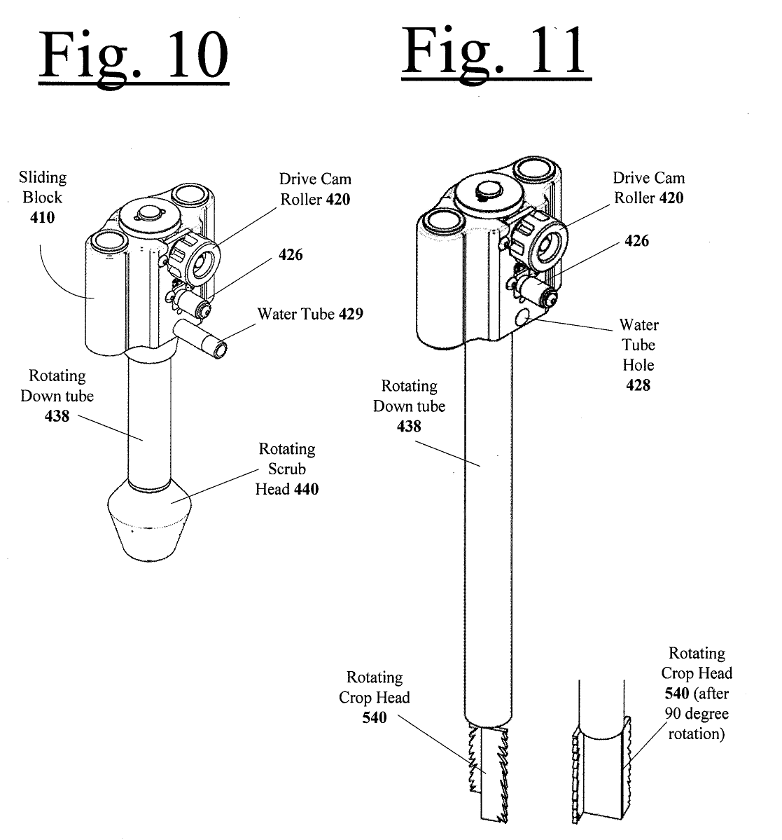

Generally described, the bird cleaning apparatus 10 accepts poultry (a.k.a. “bird” elements such as 5 in FIG. 1) being conveyed along the track assembly 20, inserts and removes the lower ends of module assemblies 400 (which could include differing lower elements as shown in FIGS. 10 and 11) into and from the interior of poultry carcasses.

The coordination of the placement of the module assemblies 400 into and out of the poultry elements as they are conveyed along the track assembly 20 is assisted with the use of cleaning assembly 110.

For purposes of this description, the rotational axis of the various components around the central shaft of the device will be assumed to be substantially vertical, although this is only a relative term for purposes of discussion.

Track Assembly 20

Reference is made for example to FIG. 1. Track assembly 20 preferably comprises hangar guide 30, sprocket wheel 40 and conventional hangers 50, wherein hangers 50 comprise loops 60 preferably disposed at the bottom thereof. Hangar guide 60 is shown which provide guidance for the hangars as they go along their path around the device 10. Chain connecting the hangars 50 is not shown, but is such as that well known in the art. This is the chain that drives the sprocket wheel 40.

The hangar guide track 30 is substantially continuous and is such as known in the art. The hangars 50 (a.k.a., shackles) are likewise well known in the art as devices which transport chicken or other poultry via a processing plant under its own motive force.

It should be understood that the chain (not shown) driving the hangars likewise provides the motive force to provides various rotational and linear operations of the apparatus 10 as described below.

The sprocket wheel 40 is such as that known in the art, to the extent it is rotatably mounted about a substantially vertical axis by external means (not shown), such that the sprocket wheel 40 can continue to rotated even if the apparatus 10 is withdrawn downwardly and away from the sprocket wheel for cleaning and/or maintenance as discussed in the prior art above. This substantially vertical axis is preferably aligned with the central shaft axis of the apparatus 10 as described further below.

The sprocket wheel may rotate at various speeds as needed, but a “sprocket speed” will be referenced in this discussion as the speed at which the sprocket is rotating. As various elements rotate or move in sync with the sprocket, they may be referenced as moving at “sprocket speed”.

A bearing assembly 41 provides lateral support to the upper end of the shaft 100 described below, while still allowing the upper end of the shaft 100 to be moved downwardly relative to the bearing assembly 41.

Shaft 100

The shaft 100 includes an upper tip portion which may be viewed in FIG. 1, and is configured to be slid in and out of the bearing assembly 41 which is attached relative to the sprocket wheel 40 as shown in Figure This allows the upper end of the shaft 100 to be withdrawn downwardly relative to the bearing assembly 41 for cleaning and/or service of the apparatus 10.

The shaft 100 does not rotate. As discussed in detail below it provides rotational support for various elements later discussed. It is bolted at its bottom by means not shown.

For purposes of later discussion, a “central shaft axis” is herein defined as the central longitudinal axis of the shaft, which in one preferred embodiment is substantially vertical. It will be seen that various components of this device rotate about this axis.

Cleaning Assembly 110

The cleaning assembly 110 includes the following general elements:
Upper Plate 120 (rotates with sprocket about central shaft axis)
Timing Plate 121 (rotates with sprocket about central shaft axis)
Drive pins 122 (rotate with sprocket about central shaft axis)
guide rails 130 (rotate with sprocket about central shaft axis)
lower plate 140 (rotates with sprocket about central shaft axis)
module camming drum 160 (stationary)
   cam channel 162
   upper camming rails 163
   lower camming rails 164
      camming gear tooth 165

The general function of the cleaning assembly 110 is to support and coordinate placement of the wand assemblies 300 into and out of the poultry elements as they are conveyed along the track assembly 20. Generally described, the cleaning assembly provides guidance for the wand assemblies 300 described later in this application such that a desired portion of each of the wand assemblies 300 can be inserted into the chest cavity of a bird according to a predetermined timing and placement protocol.

The upper plate 120, guide rails 130, and lower plate 140 are mounted together as a substantially rigid “cagelike” subassembly (which may be referenced as a “slide bar cage assembly” which rotates with the sprocket about the central shaft axis. The upper and lower plates 120, 140, are substantially platelike and have their major planar surfaces substantially parallel and horizontal when installed.

The guide rails 130 are elongate and cylindrical, and in the preferred embodiment are mounted in set of parallel pairs, with each pair associated with a corresponding one module assembly 400. As may be understood, these pairs of guide rails 130 provide vertical paths for the module assemblies 400 to move relative thereto, while at the same time the guide rails 130 themselves are rotating about the central shaft axis of the device 10, thus moving the module assemblies 400 along a path which both goes up and down while in coordination with the birds 5 as they pass along a portion of their path.

The upper plate 120 is rotatably supported relative to the shaft by an upper plate bearing assembly 123. The upper plate bearing assembly 123 provides vertical positioning of the upper plate on the central shaft 100, and also provides a rotational bearing about the central shaft axis.

The lower plate 140 includes a plurality of loop openings 142, and is rotatably supported relative to the shaft by a lower plate bearing assembly 143. These loop openings 142 provide location for conveyed birds as known in the art, and in the present invention the head and down pipe of the modules pass into and out of these loops as they index downwardly and upwardly. The lower plate bearing assembly 143 provides vertical positioning of the upper plate on the central shaft 100, and also provides a rotational bearing about the central shaft axis.

Lower plate 140 rotates, and may or may not drive further elements there below as needed.

A timing plate 121 is rigidly mounted atop the upper mounting plate 120 and rotates therewith. This timing plate 121 is configured to allow for the timing between the sprocket wheel 40 and the rotating upper plate 120, guide rails 130, lower plate 140, and the wand assemblies 300, such that the hangars remain disposed in adjacent position to module assemblies 400 as hangers 50 traverse around cleaning assembly 110. Although the adjustment feature could be provided in many ways, one preferred way is to provide headed fasteners having engaging ends passing through holes in the timing plate 140, through adjustment slots (not shown) in the upper plate 120, and which are engaged by captured nuts or the like underneath and against the upper plate. The goal is to allow for torque to be transferred from the upper plate 121 to the timing plate 121 while allowing occasional angular adjustment to address timing.

Rigidly attached atop the timing plate 121 are two drive pins 122 which allow the sprocket wheel to drive the timing plate, and this drive other elements such as 120, 130, 140 as well at the same rotational speed. The lower ends of each of the drive pins 122 are rigidly attached relate to the timing plate 121; the upper ends of each of the drive pins 122 slidably engage vertical holes spaced 180 degrees from each other. As may be understood, this allows the top ends of the drive pins 122 to become disengaged with the sprocket as the shaft 100 is withdrawn downwardly is lowered for maintenance or cleaning purposes of the device 10 as described elsewhere.

The stationary module camming drum 160 is stationary and includes upper camming rails 163 and lower camming rails 164, which combine with the side of the drum to define a cam channel 166. The stationary module camming drum 160 is mounted relative to the shaft by a centrally located hub which is secured to the shaft by two bolts (not shown) 180 degrees apart. Thus any rotation (not during bird processing but during adjustment of the apparatus) of the shaft 100 causes rotation of the drum 160 and vice versa.

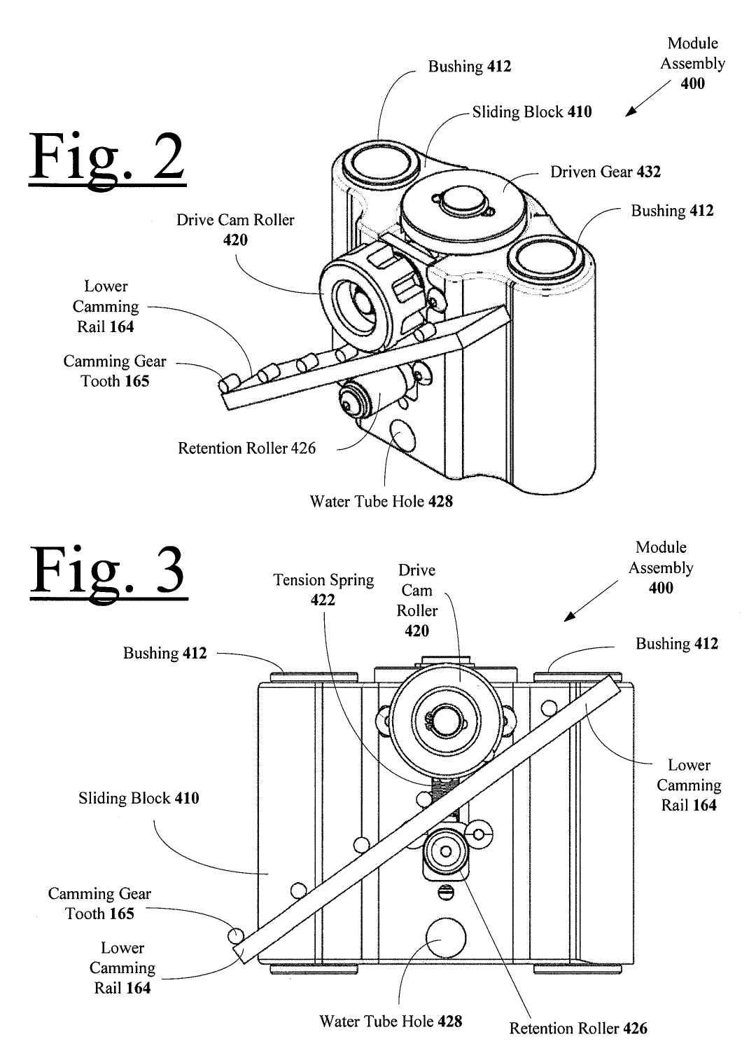

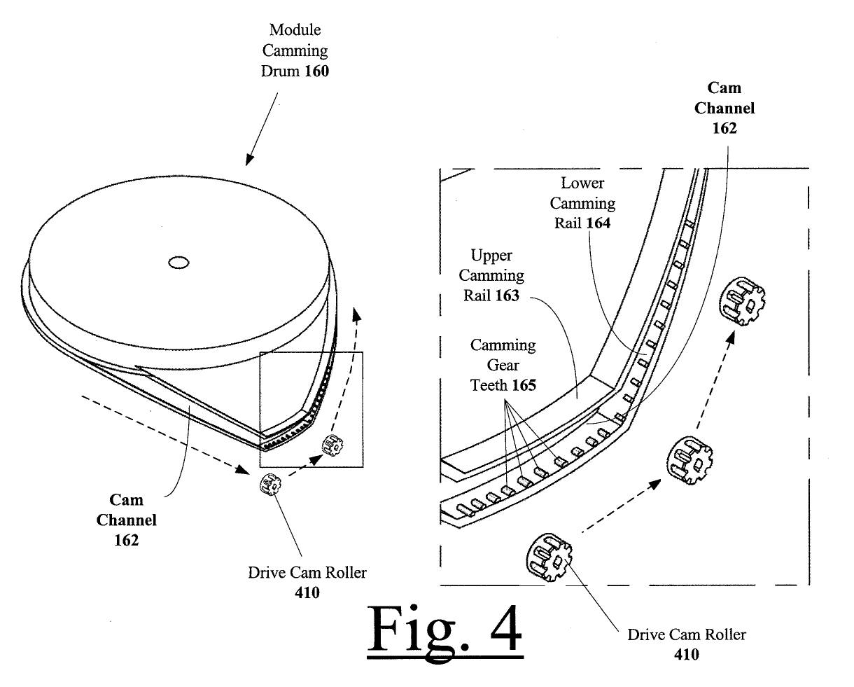

One function of the stationary module camming drum 160 is to define a path to accept and drive cam rollers 420 associated with the module assemblies 400 to cause the module assemblies to move up and down on their respective guide rails 130, thus causing the lower, “working” ends of the modules to go in and out of the bird cavities while processing as desired. The cam channel 162 also includes discrete gear teeth 165 (see FIGS. 2 and 3 for example) which also rotate the drive cam rollers so they provide torque sufficient to rotate cropping or cleaning member as described in detail elsewhere.

Module Assemblies 400

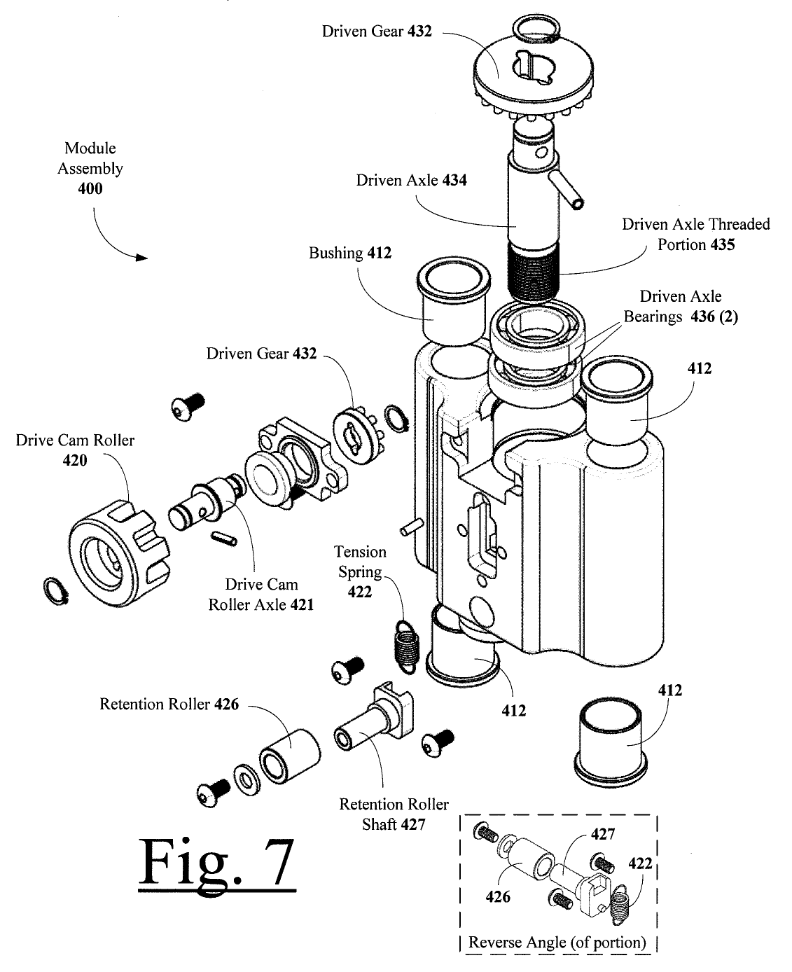

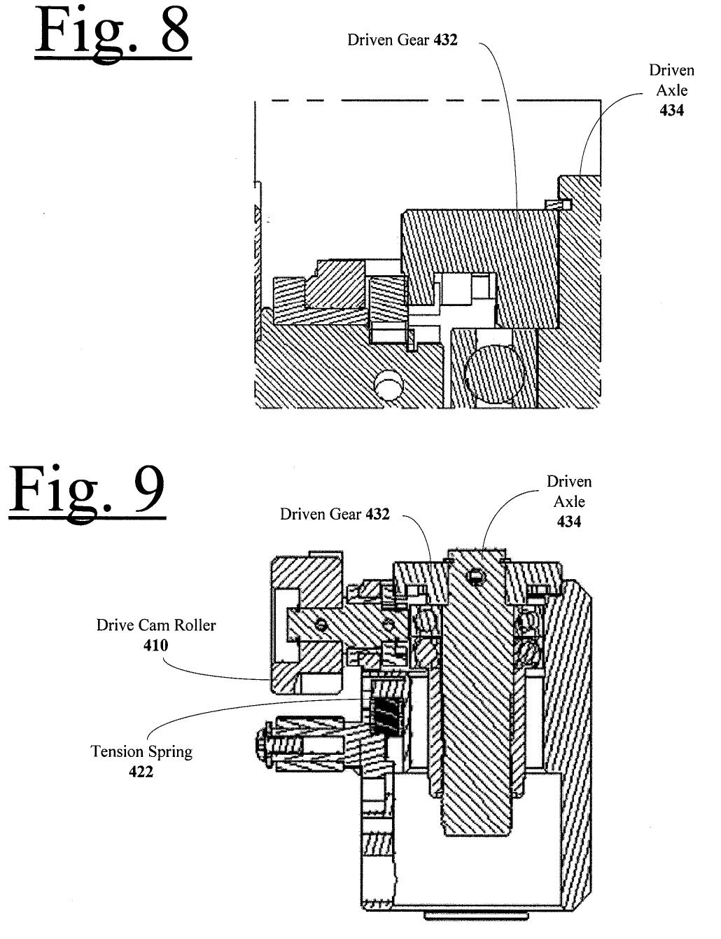

A plurality of module assemblies 400 (see for example FIGS. 2, 3, and 7), are preferably disposed symmetrically about cleaning assembly 110.

Each module assembly 400 includes the following elements and features:
Sliding Block 410
   Bushings 412 (4)
Drive Cam Roller 420
Drive Cam Roller Axle 421
Tension Spring 422
Retention Roller 426
Retention Roller Shaft 427
Water Tube Hole 428
Water Tube 429
Drive Gear 430
Driven Gear 432
Driven Axle 434
Driven Axle Threaded Portion 435
Driven Axle Bearings (2) 436
Down tube 438
Rotating Scrub Head 440 (tendrils shown)
Rotating Crop Head 540

Each sliding block 410 includes four bushings 412, configured to allow for sliding on the guide rails 130.

Drive cam roller 420 is rigidly mounted on drive cam roller axle 421, such that rotation of one causes rotation of the other. Drive gear 430 is rigidly mounted on drive cam roller axle 421, such that rotation of one causes rotation of the other. Thus elements 420, 421, and 430 rotate as a unit and in conventional operation rotate along a horizontal axis.

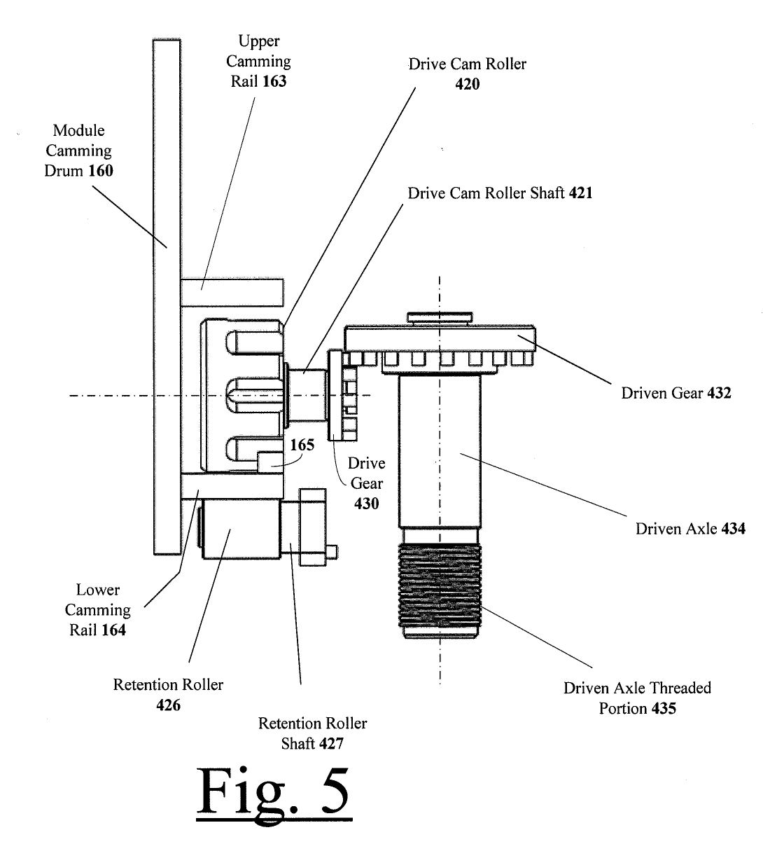

Drive gear 430 is in toothed engagement with driven gear 423 as shown in FIG. 5. Rotation of drive gear 430 causes rotation of driven gear 423.

Driven gear 432 is rigidly mounted on driven axle 434, such that rotation of one causes rotation of the other. Driven axle threaded portion 435 is part of driven axis 434. Thus elements 432, 434, and 435 rotate as a unit and in conventional operation rotate along a vertical axis. Thus rotation of drive cam roller 420 causes rotation of driven axle threaded portion, and anything threaded onto it.

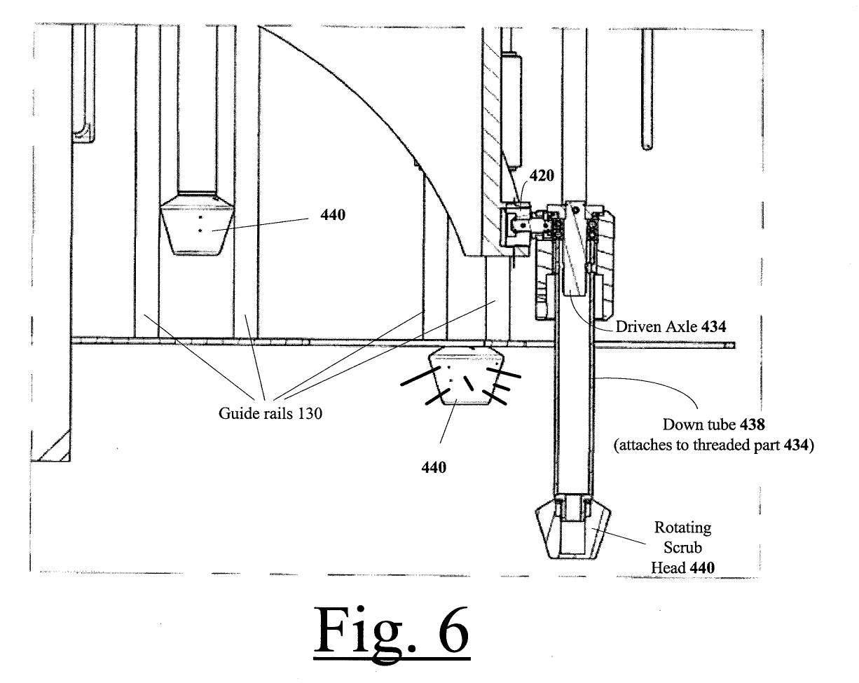

The threaded portion 435 of driven axis 434 is configured to allow for attachment of various attachment members such as exemplary rotating scrub head 440 (see FIGS. 6 and 10 or example) or exemplary rotating crop head 540 (see FIG. 11). Thus rotation of drive cam roller 420 causes rotation of the exemplary rotating scrub head 440 if attached, or exemplary rotating crop head 540, if attached.

The construction and operation of the rotating scrub head 440 is such as that shown in the incorporated U.S. Pat. No. 7,537,515, in that it includes flexible tendrils as well as cleaning ports and associated cleaning fluid dispensers.

Operation of Module Assembly 400

The drive cam roller 420 fits within the channel 162 of the module camming drum 160, and is indexed up and down thereby, as the sprocket wheel 40 rotates and the roller 420 rolls atop the stationary lower camming rail. The drive cam roller 420 also engages the stationary teeth on the stationary lower camming rail, and thus rotates in rolling toothed engagement. As noted above, rotation of drive cam roller 420 causes rotation of the exemplary rotating scrub head 440 if attached, or exemplary rotating crop head 540, if attached.

In order to keep the drive cam roller 420 engaged with the lower camming rail 164, a floating retention roller 426 is used, which is biased against the lower surface of the lower camming rail 164 by the use of tensile spring force. The floating retention roller 426 is idle mounted to a retention roller shaft that is allowed to “float” up and down with its axis remaining horizontal.

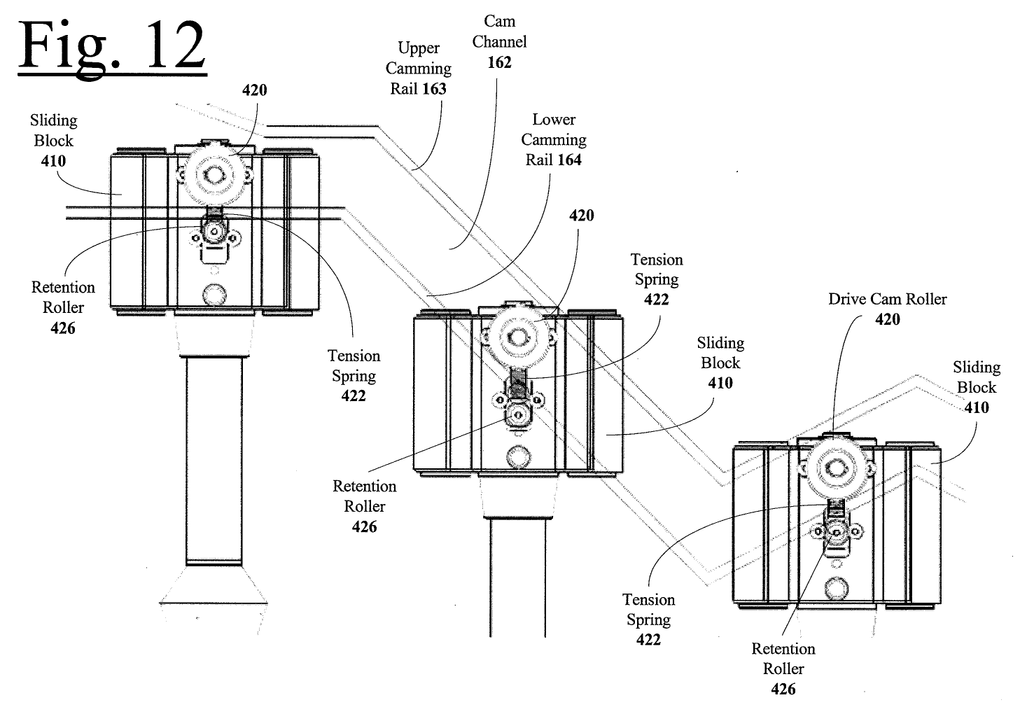

FIG. 5 shows the contact between the floating retention roller 426 and the lower surface of the lower camming rail 164. FIG. 12 shows the way the rotational axis of the retention roller 426 moves downwardly relative to the rotational axis of the drive cam roller 420, while being biased upwardly due to a tension spring 422 between the retention roller shaft 427 and the sliding block 410. Although a spring could be used, other retaining and/or biasing configurations could also be used, such as a urethane shape, or a piece of material such a plastic piece horizontal to acting as a bow. The primary concern is that the drive cam roller 420 remain engaged with the engagement elements used with or in place of lower camming rail 164.

It may be seen that the upper camming rail could be eliminated assuming the floating retention roller 426 is sufficiently robust.

Variations and Options

As noted above, an exemplary rotating scrub head 440 or exemplary rotating crop head 540 could be used. Other attachments could include a vent cutter, rotating lung vacuum head, etc.

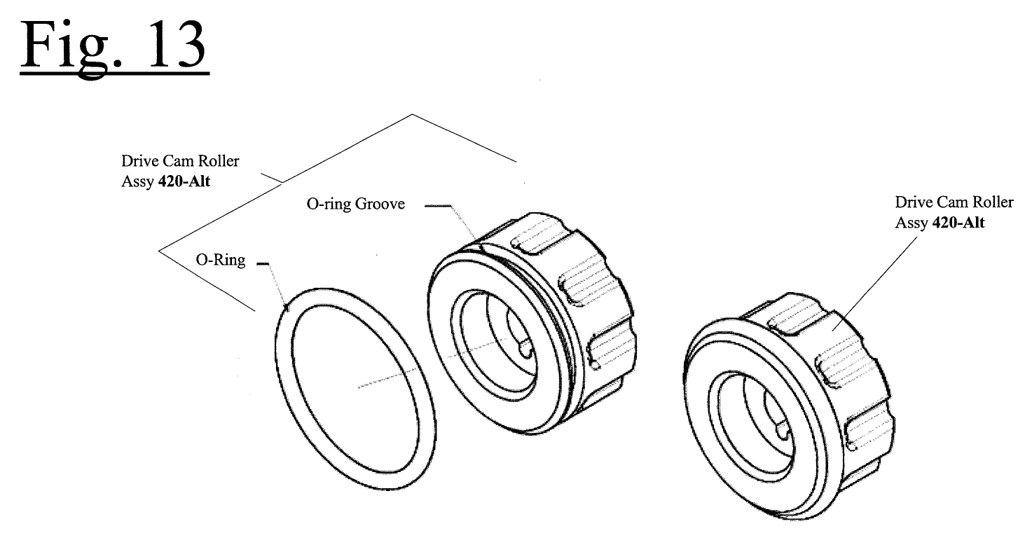

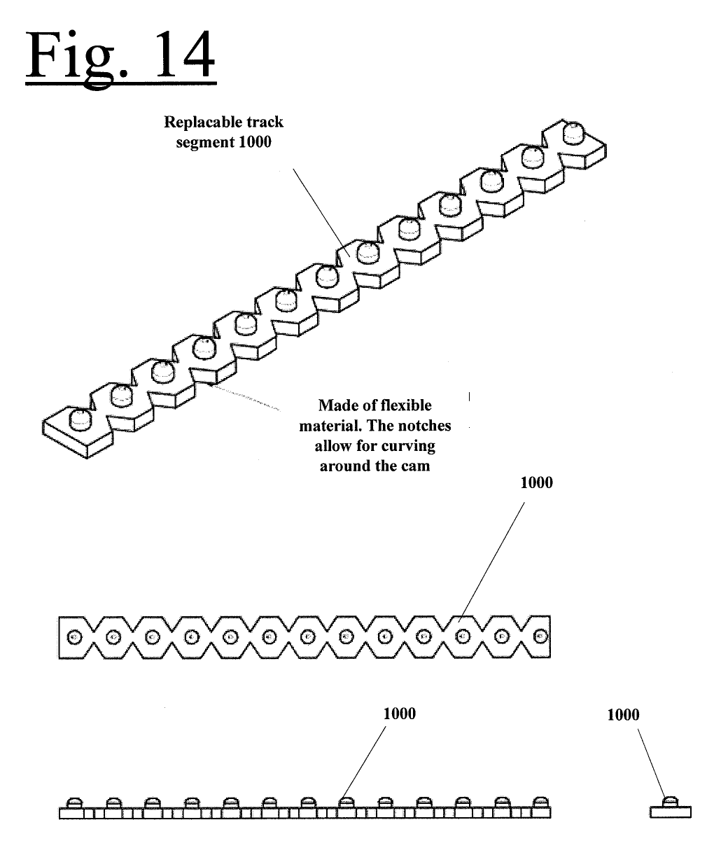

FIG. 13 shows an alternative drive cam roller assembly 420 configuration, which includes the use of an O-ring in order to assist the transfer of torque to the drive cam roller assembly 420 due to contact between the O-ring (attached to the drive cam roller assembly 420) and the preferably smooth upper surface of the lower camming rail 164. Thus rolling engagement is provided at least in part by a substantially smooth frictional engagement between said drive cam roller and said cam following rail. It should also be understood that this substantially smooth frictional engagement between said drive cam roller and said cam following rail could be the sole manner in which rolling engagement is provided.

FIG. 14 shows an alternative to the caroming gear teeth 165, in that a replaceable track segment 1000 made of flexible material is configured to be selectively attached to the upper surface of the lower camming rail 164. The notches allow for curving around the cam. Attachment can be done by riveting, or screw type fastener from under side, or other suitable means.

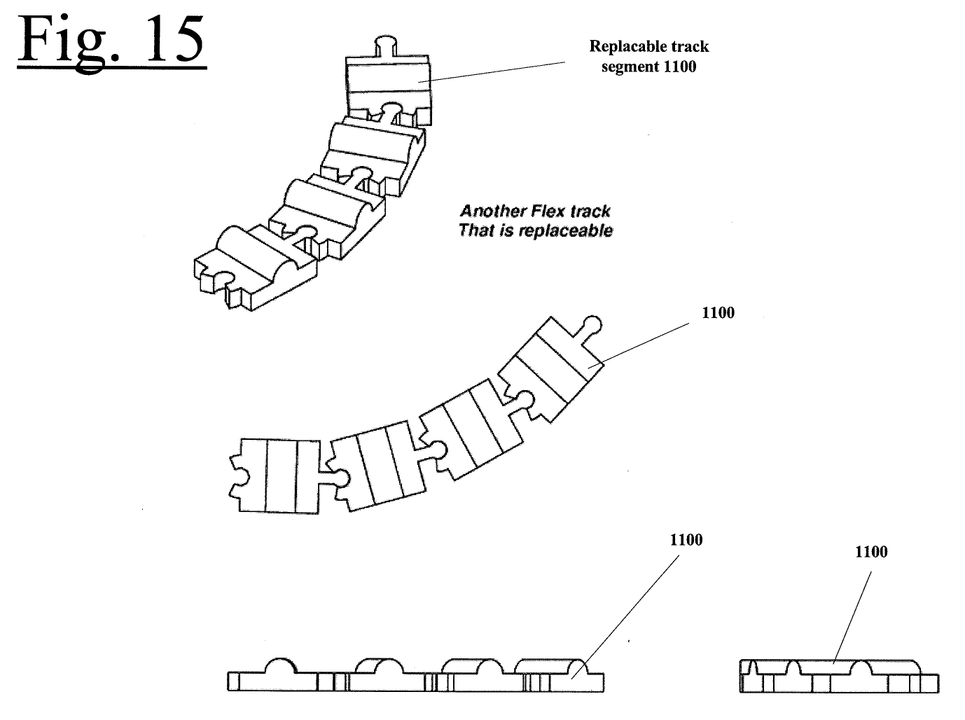

FIG. 15 shows an alternative to the camming gear teeth 165, in that multiple replaceable track segments 1100 made of flexible material are configured to be selectively attached to the upper surface of the lower camming rail 164. The lengths of each segment can vary as desired. The interconnections allow for curving around the cam. Attachment can be done by riveting, or screw type fastener from under side, or other suitable means.

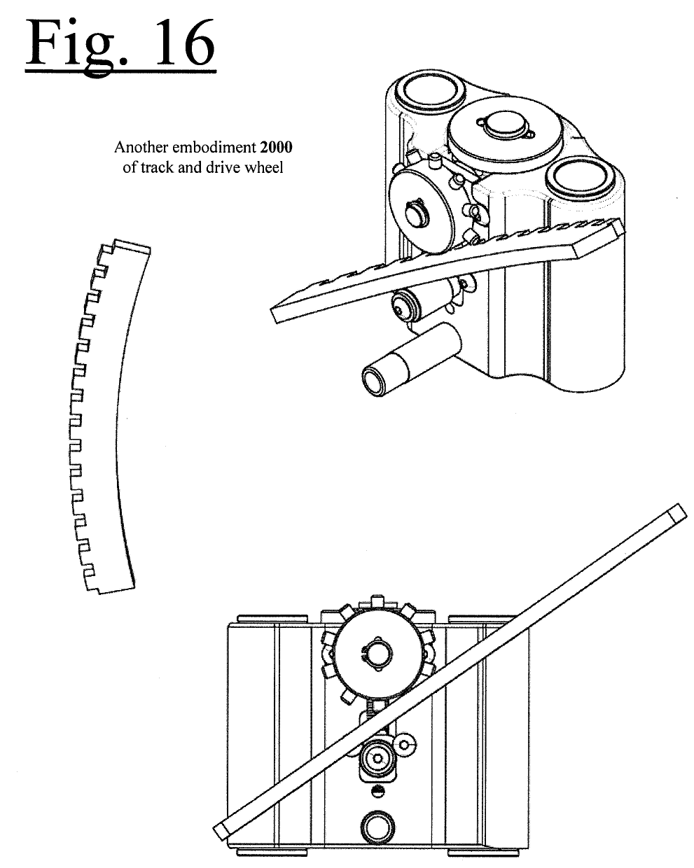

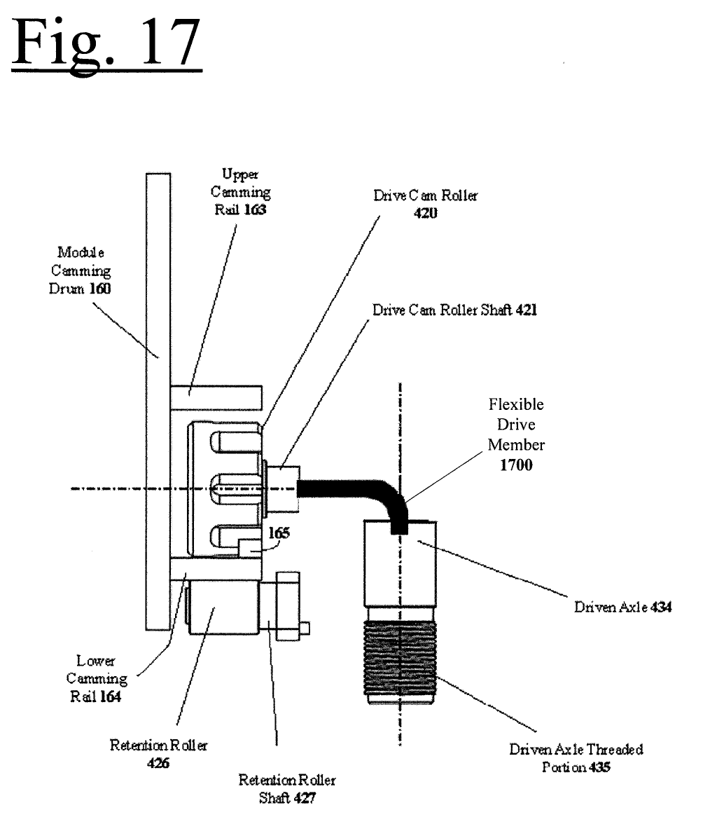

FIG. 16 shows an alternative configuration which includes a track with notches which is engaged by a drive wheel with slightly differently shaped teeth.

FIG. 17 shows an alternate flexible cable drive member 1700 could be used from 421 to 434 such as for example a speedometer cable. The cable replaces the right angle gear interaction.

Various Options

As noted elsewhere, options as far as alternative attachments include a vent cutter, lung vacuum attachment, etc. Instead of bearing 436, bushings with a lubricant property could also be used.

Advantages

Therefore it may be seen that the configuration described above eliminates the need for rotation of the lower tip by the separate square shaft of the configuration shown in U.S. Pat. No. 7,537,515, which is driven by a gear 330 attached thereto which engages and is driven by a main ring gear 130.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Element List
apparatus 10
track assembly 20
hangar guide 30
sprocket wheel 40
bearing assembly 41
conventional hangers 50
hangar guide 60
shaft 100
cleaning assembly 110
   upper plate 120
Timing plate 121
Drive pins 122
upper plate bearing assembly 123
guide rails 130
lower plate 140
loop openings 142
lower plate bearing assembly 143
module camming drum 160
   upper camming rails 163
   lower camming rails 164

Module Assemblies 400
Sliding Block 410
   Bushings 412 (4)
Drive Cam Roller 420
Drive Cam Roller Axle 421
Tension Spring 422
Retention Roller 426
Retention Roller Shaft 427
Water Tube Hole 428
Water Tube 429
Drive Gear 430
Driven Gear 432
Driven Axle 434
Driven Axle Threaded Portion 435
Driven Axle Bearings (2) 436
Down tube 438
Rotating Scrub Head 440
Rotating Crop Head 540
Flex member 1700

That which is claimed:

1. A machine for cleaning at least part of an internal cavity in each of a plurality of fowl traveling along a conveying path, each said internal cavity having an upwardly-directed access opening, said machine comprising:
a cam following rail;
a module assembly itself including:
a module assembly body configured for moving upwardly and downwardly relative to one of said fowl along at least a part of said conveying path;
an elongate fowl processing element including a working lower tip portion configured for insertion to and withdrawal from at least one internal cavity through said access opening, said elongate fowl processing element being rotatably mounted relative to said module assembly body about a first axis such that said working lower tip rotates within said internal cavity;
a drive cam roller rotatably mounted relative to said module assembly body about a second axis substantially perpendicular to said first axis, said drive cam roller in rolling engagement with said cam following rail, such that as said drive cam roller rolls along in engagement with said cam following rail, said working lower tip portion moves up and down within said internal cavity along a path substantially parallel to said second axis; and
a power transmission subassembly intermediate said drive cam roller and said elongate fowl processing element, said power transmission subassembly configured to transmit power from said drive cam roller to said elongate fowl processing element such that said rolling engagement of said drive cam roller with said cam following rail causes rotation of said working lower tip portion about said second axis at least part of the time said working lower tip portion is within said internal cavity.

2. The machine as claimed in claim 1, wherein said rolling engagement is a toothed engagement between spaced apart teeth on said drive cam roller and spaced apart teeth on said cam following rail.

3. The machine as claimed in claim 2, wherein said spaced apart teeth on said cam following rail are individually mounted on said cam following rail.

4. The machine as claimed in claim 2, wherein said spaced apart teeth on said cam following rail are mounted on said cam following rail via use of replaceable sections each including a plurality of teeth.

5. The machine as claimed in claim 1, wherein said rolling engagement is a substantially smooth frictional engagement between said drive cam roller and said cam following rail.

6. The machine as claimed in claim 1, wherein said rolling engagement is a combination of a) toothed engagement between spaced apart teeth on said drive cam roller and spaced apart teeth on said cam following rail; and b) rolling engagement is a substantially smooth engagement between said a smooth portion of drive cam roller and said a smooth portion of said cam following rail.

7. The machine as claimed in claim 1, further comprising a retention member mounted relative to said module assembly body such that a portion of said cam following rail is captured between said drive cam roller and said retention roller, such that said drive cam roller is retained in rolling engagement with said cam following rail.

8. The machine as claimed in claim 7, wherein said retention member is a retention roller in rolling contact with said cam following rail.

9. The machine as claimed in claim 8, wherein said retention roller is biased against one side of said cam following rail and said cam drive cam follower is in contact with a second side of said cam following rail, said second side being opposite said first side.

10. The machine as claimed in claim 9, wherein said biasing of said retention roller is provided by a spring biased shaft supporting said retention roller.

11. The machine as claimed in claim 1, wherein said power transmission assembly includes a gear drive.

12. The machine as claimed in claim 1, wherein said power transmission assembly includes a flexible cable drive.

13. The machine as claimed in claim 1, wherein said lower portion of elongate fowl processing element included a cleaning head including flexible tendrils as well as cleaning fluid dispensers.

14. The machine as claimed in claim 1, wherein said lower portion of said elongate fowl processing element includes a cropper head for removing the crop.

15. A method for cleaning at least part of an internal cavity in each of a plurality of fowl traveling along a conveying path, each said internal cavity having an upwardly-directed access opening, said method comprising the steps of:
A) providing a machine comprising:
1) a cam following rail; and
2) a module assembly itself including:
a) a module assembly body configured for moving upwardly and downwardly relative to one of said fowl along at least a part of said conveying path;
b) an elongate fowl processing element including a working lower tip portion configured for insertion to and withdrawal from at least one internal cavity through said access opening, said elongate fowl processing element being rotatably mounted relative to said module assembly body about a first axis such that said working lower tip rotates within said internal cavity;
c) a drive cam roller rotatably mounted relative to said module assembly body about a second axis substantially perpendicular to said first axis, said drive cam roller in rolling engagement with said cam following rail, such that as said drive cam roller rolls along in engagement with said cam following rail, said working lower tip portion moves up and down within said internal cavity along a path substantially parallel to said second axis; and
d) a power transmission subassembly intermediate said drive cam roller and said elongate fowl processing element, said power transmission subassembly configured to transmit power from said drive cam roller to said elongate fowl processing element such that said rolling engagement of said drive cam roller with said cam following rail causes rotation of said working lower tip portion about said second axis at least part of the time said working lower tip portion is within said internal cavity; and
B) operating said machine such that:
1) said drive cam roller is rotatably driven by said cam following rail, such that as said drive cam roller rolls along in engagement with said cam following rail, said working lower tip portion moves up and down within said internal cavity along a path substantially parallel to said second axis; and
2) said power transmission subassembly transmits power from said rotating drive cam roller to said elongate fowl processing element such that said rolling engagement of said drive cam roller with said cam following rail causes rotation of said working lower tip portion about said second axis at least part of the time said working lower tip portion is within said internal cavity.
